(19) United States
(12) Patent Application Publication
(10) Pub. No.: US 2012/0078672 A1
(43) Pub. Date: Mar. 29, 2012

(54) Efficient Automated Ride Sharing System

(75) Inventors: Matthew Mohebbi, Potomac, MD (US); Cosmin Vlad Ditu, Gaithersburg, MD (US); Muhammad Imran Younus Siddiqui, Lahore (PK)

(73) Assignee: IT Curves LLC, Gaithersburg, MD (US)

(21) Appl. No.: 13/247,446

(22) Filed: Sep. 28, 2011

Related U.S. Application Data
(60) Provisional application No. 61/387,764, filed on Sep. 29, 2010.

(51) Int. Cl. G06Q 10/06; G01C 21/34

(52) U.S. Cl. 705/7.12; 701/527

(57) ABSTRACT

An automated method for establishing ride-sharing routes is disclosed. A plurality of requests for transportation between a plurality of start locations and a plurality of end locations is received. A route is determined that includes the plurality of start locations and plurality of end locations as a function of at least one of the following criteria: a service level agreement with at least one transportation requestor, real time traffic conditions real time weather conditions, and distance between the first start location and the last end location. A mobile resource is selected that satisfies at least one of the criteria relied on to determine the route. The determined route information is transmitted to the selected mobile resource. Confirmation of the transmitted route information is received from the selected mobile resource.

### CROSS-REFERENCE TO RELATED APPLICATIONS

This application claims the benefit of the filing date of U.S. Provisional Application No. 61/387,764, filed Sep. 29, 2010, the disclosure of which is incorporated herein by reference as though set forth in full below. This application is also related to concurrently filed U.S. patent application Ser. No. ______, (Attorney Docket No. 3023.0010001), the disclosure of which is incorporated herein by reference as though set forth in full below.

### BACKGROUND

1. Field

The present disclosure relates to methods and apparatus for a system to automatically form routes for ride sharing and dynamically maintain the routes as traffic or other reasons cause delay or change to routes.

2. Background

Transportation scheduling is the process of planning how to move items from one location to another location using a fleet of carriers and under a set of restrictive constraints. One example is demand-response para-transit scheduling. In this example, wheelchair-bound and ambulatory customers make requests by telephone for round trip transportation from home to medical appointments, shopping, community centers, etc. A fleet of vehicles must provide service under a multitude of constraints such as: (1) honoring a requested pick up time, (2) dropping the customer off before, but at most within a given time-window (e.g., 60 minutes) before the appointment time, (3) and planning for much slower travel speed during rush hours.

Transportation scheduling takes a collection of trip requests as its set of subgoals, and a fleet of vehicles as its resources. The scheduling process constructs a set of manifests, one for each vehicle-shift. A manifest is an ordered sequence of stop events. Each event has an associated location (either pickup or drop-off) and an assigned time.

The set of manifests or schedule must be realistic (known in the art as “streetability”), satisfy all domain constraints (known in the art as “correctness”), and be of high quality (known in the art as “goodness”).

Previous attempts to solve the transportation scheduling problem have been varied. Although these prior attempts have been moderately successful, some of these methods are computationally intensive, most have to done the day before, and typically use a paper manifest. Thus, there is still a need for an, easily implementable method for transportation scheduling that accurately models the problem and can be operated in real time and dynamically relying on in-vehicle smart devices.

### BRIEF SUMMARY

An automated method for establishing ride-sharing routes is disclosed. A plurality of requests for transportation between a plurality of start locations and a plurality of end locations is received. A route is determined that includes the plurality of start locations and plurality of end locations as a function of at least one of the following criteria: a service level agreement with at least one transportation requestor, real time traffic conditions real time weather conditions, and distance between the first start location and the last end location. A mobile resource is selected that satisfies at least one of the criteria relied on to determine the route. The determined route information is transmitted to the selected mobile resource smart devices. Confirmation of the transmitted route information is received from the selected mobile resource via the smart device.

### BRIEF DESCRIPTION OF THE DRAWINGS/FIGURES

Embodiments are described with reference to the accompanying drawings. The accompanying drawings, which are incorporated herein and form a part of the specification, illustrate embodiments and, together with the description, further serve to explain the principles of the embodiments and to enable a person skilled in the relevant art to make and use the embodiments. In the drawings, like reference numbers may indicate identical or functionally similar elements. The drawing in which an element first appears is generally indicated by the left-most digit in the corresponding reference number.

FIG. 1 shows the methodology, terms and some of the setup of constraints, optimized parameters and their relationship

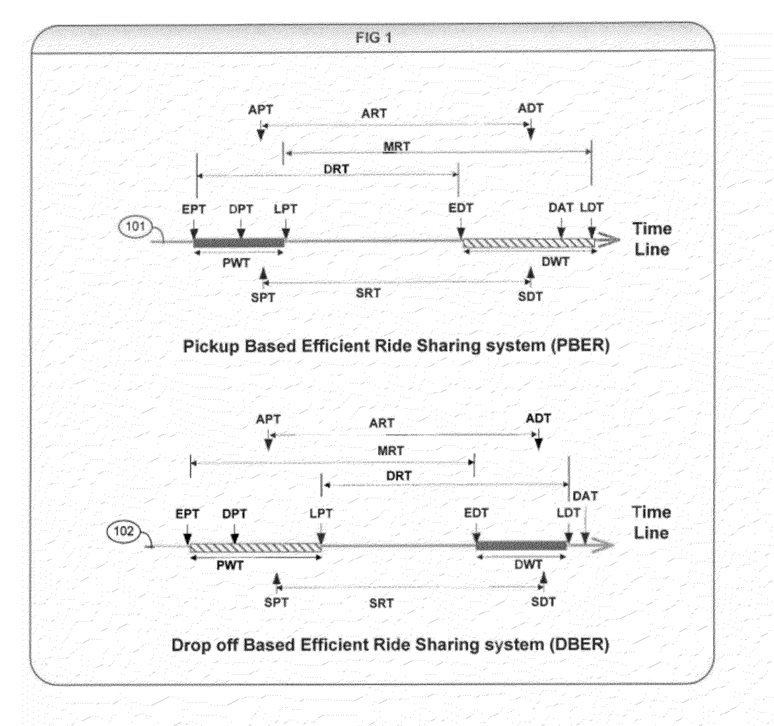

FIG. 2 shows an overall system diagram of an embodiment of the Efficient Ride Sharing System (ESSR) context diagram

FIG. 3 shows a flow chart of the Efficient Ride Sharing System Flow Diagram

FIG. 4 is a screen shot of Efficient Ride Share Parameters Setting

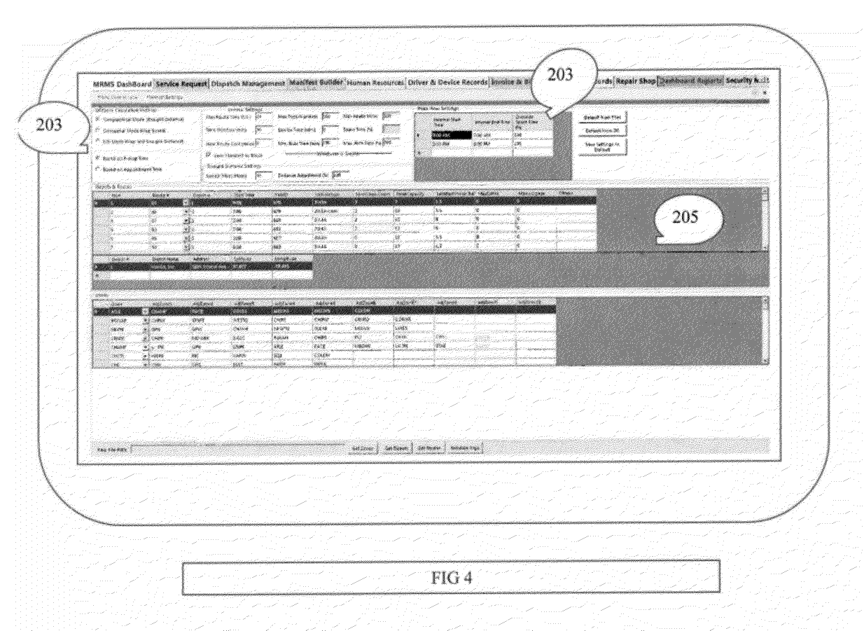

FIG. 5 are multiple screen shots of a Manifest Builder, where the system forms Ride Sharing Routes

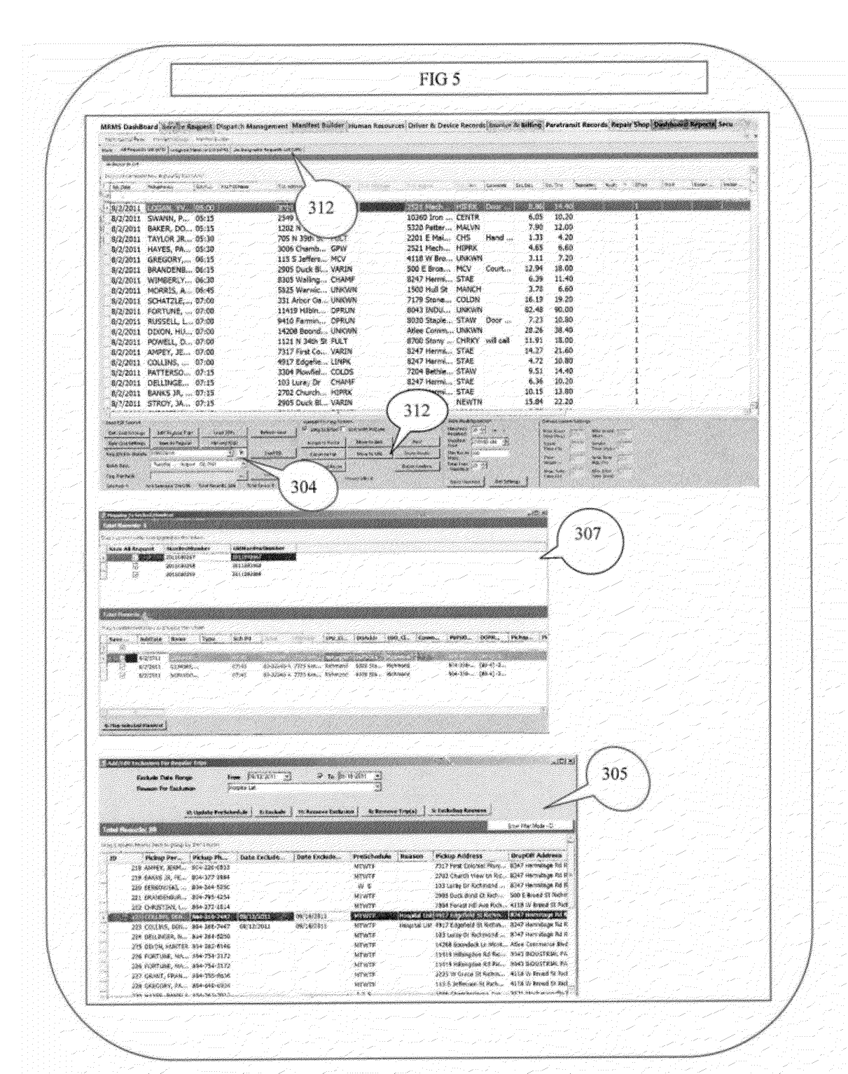

FIG. 6 is a screen shot of an in-vehicle Android device where manifests are dispatched to drivers and maintained electronically during the day.

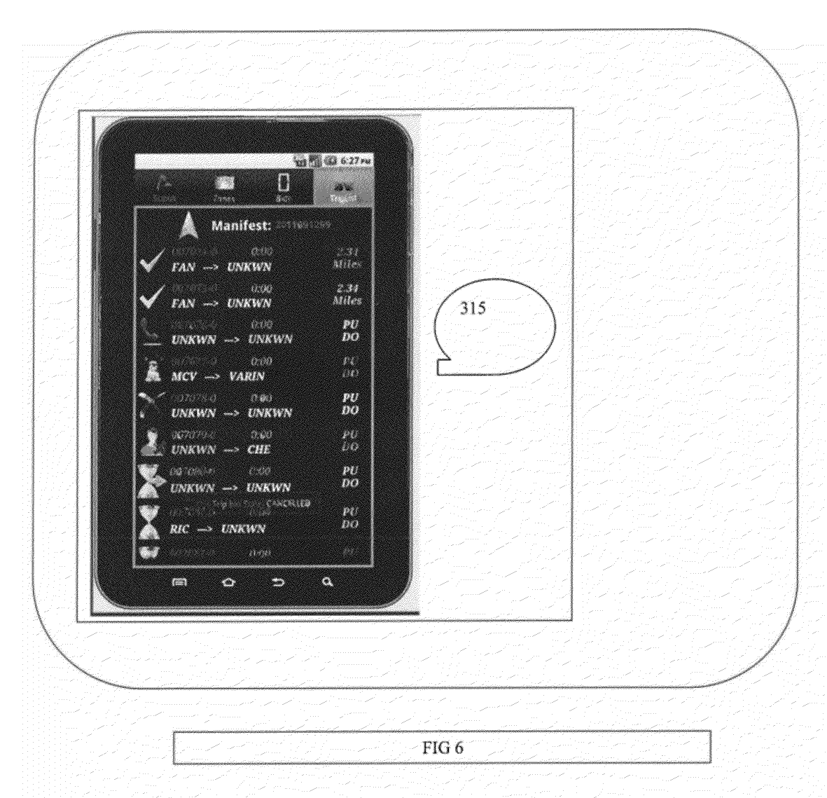

### DETAILED DESCRIPTION

In the detailed description that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. This invention may be embodied in hardware, software, firmware, or any combination thereof.

The Efficient Ride Sharing System (ERSS) described in this disclosure considers a number of independent system variables which are defined by contract, level of service, or laws and regulations. Based on these independent variables and certain constraints it then defines certain dependent variables.

This disclosure relates to a method and system for automated route making for a pool of passengers who wish to share rides within certain constraints and with a certain degree of service level freedoms in order to optimize certain economic parameters. The system knows some of the service requests in advance (static or advance service requests). Some of the service requests may come in as the routes are forming or during the operating time of the routes (dynamic or real-time Service Requests).

The economic parameters that are optimized include capital cost for purchase of additional equipment and vehicles, and operating costs associated with reducing fuel usage and reducing operating hours to the shortest time. This disclosure considers the most optimal assignment of trip pickups or start locations and trip drop offs or end locations to some routes with the objective of using the smallest number of vehicles, and the shortest routes for each of the vehicles.

The static part of the algorithm implementation takes a pool of service requests that have come in prior to the start of the algorithm and a pool of participating vehicles that start up from a number of known locations or depots. Each service request has a time and date of service associated with it, and each participating vehicle has a start or depot location and start time associated with it. Service requests have mandatory and desirable attributes associated with them. On the other hand the pool of vehicles associates each vehicle with a start time and a number of attributes such as start time, type of vehicle, and capacity.

The dynamic part of the system accepts service requests and tries to find the nearest vehicle to the service request with the shortest deviation from its path, and most optimal time. The dynamic model can also respond to changing traffic, rush hours, and a change in pattern of pickup or start location or drop off or end location due to late cancelations. The route continuously changes as these conditions are changing. The vehicles are equipped with GPS and Automatic Vehicle Locator (AVL) and smart devices. Therefore, the system can constantly evaluate the progress of vehicles and may remove certain trips or add certain trips to the route as the route progresses.

Both the static model and dynamic model, while optimizing the total route time, comply with certain constraints, such as keeping the pick up within a set time window (TPW), Maximum Ride Time (MRT) for any passenger, and total driving duration. Some of these constraints are driven by contract or quality of service requirements, and some are driven by regulation or law.

Efficient ride share is designed to operate in two different ways. In a first method, the customer specifies the time of pickup. The ride sharing system, after determining the best fit function, then determines the route and defines the drop off window. In a second method, the customer or rider defines the time he/she needs to be at the drop off location, or at an appointment. The system performs the best fit functions and defines the time window that the customer will be picked up at the pickup location. These two methods, while they seem similar, are two different processes and take different sets of constraints and optimization rules into account.

The system can create routes based on two different techniques depending upon which sets of parameters are considered independent variables and which sets are considered dependent variables. The first technique is classified as a Pickup Based Efficient Ride Sharing system (PBER), in which the rider provides his or her desired pickup time and an allowed pickup window around the desired pickup time (see timeline 101). Certain constraints or rules create the drop off window. The second technique is called the Drop off Based Efficient Ride Sharing system (DBER), in which the rider specifies the desired drop off time and the system determines the appropriate pickup time with an allowable pickup window (see timeline 102).

In the PBER method the independent variables are defined by the rider, contract or rules and regulations. These include a Desired Pickup Time (DPT), a window around the DPT designated here as the Pickup Window Time (PWT), and a Maximum Ride Time (MRT) that the rider is willing to allow or which the contract allows a rider remain on board due to ride sharing. These variables define the degree of freedom provided to the system in its assignment of trips to the ride sharing program. One more item that may be defined as input to the system is the Route Maximum Time (RMT), which is the maximum time a route may take from the driver's point of view. This parameter is used to keep maximum driver time within regulations in commercial ride share programs, and may be used as the time a driver is willing to prolong his trip in a non-commercial ride sharing arrangement, such as High-Occupancy and local communities ride sharing (see timeline 101).

| Independent Variables | Dependent Variables |
|---|---|
| Provided by rider, contract or rules | determined by system |
| DPT: Desired Pickup Time | EPT: Earliest Pickup Time |
| PWT: Pickup Window Time | LPT: Latest Pickup Time |
| MRT: Maximum Ride Time | LDT: Late Drop Time |
| RMT: Route Maximum Time | DRT: Direct Ride Time |
| | EDT: Early Drop of Time |
| | DWT: Drop Window Time |
| | SPT: Scheduled Pickup Time |
| | SDT: Scheduled Drop off Time |
| | SRT: Scheduled Ride Time |

The second method of specifying rider share parameters and performance is based on DBER, in which the rider specifies the time he must be at a particular location. The drop off time, appointment time and other variables are driven from this fixed time. The rider, contract or Service Level Agreement (SLA) may add additional parameters, such as Drop Window Time (DWT) which is the window of time prior to which the rider is willing to be dropped at the destination. Like the PBER, a MRT may be provided. The table below shows the independent and dependent variables in the context of DBER setup (see timeline 102).

| Independent Variables | Dependent Variables |
|---|---|
| Provided by rider, contract or rules | determined by system |
| DAT: Drop or Appointment Time | EPT: Earliest Pickup Time |
| DWT: Drop Window Time | LPT: Latest Pickup Time |
| MRT: Maximum Ride Time | LDT: Late Drop Time |
| RMT: Route Maximum Time | DRT: Direct Ride Time |
| | EDT: Early Drop off Time |
| | DWT: Drop Window Time |
| | SPT: Scheduled Pickup Time |
| | SDT: Scheduled Drop off Time |
| | SRT: Scheduled Ride Time |

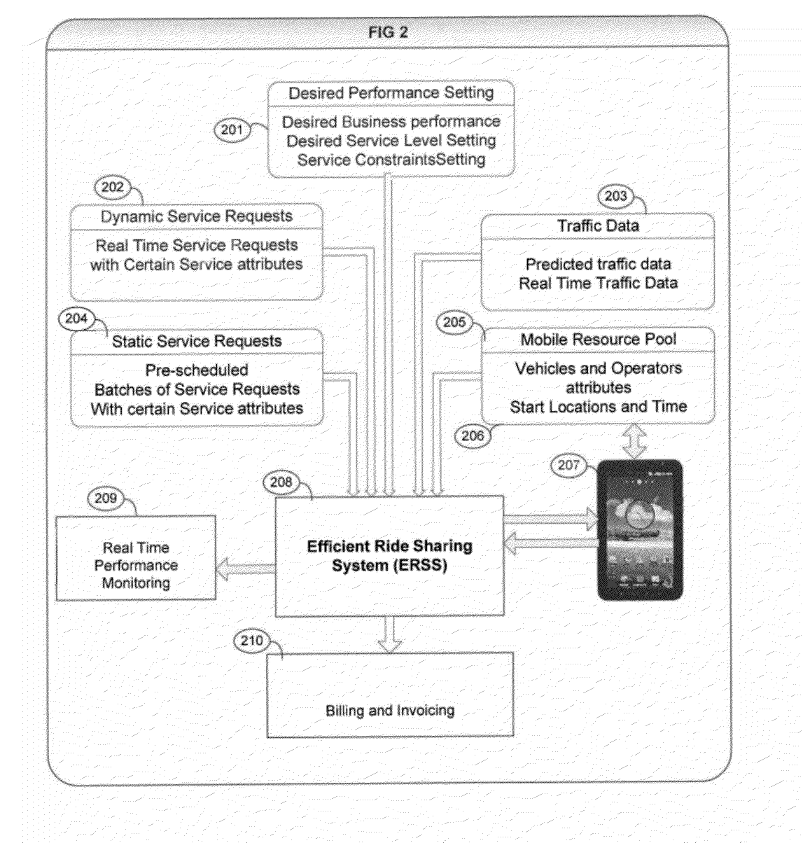

FIG. 2 shows a block diagram of the components of the ERSS. The system requires the operator to specify the business parameters 201, such as how many vehicles he will dedicate to the ride sharing services which control the capital investment. The operator also enters the number of hours he will allow each driver to drive on the day of operation, which is determined by such cost factors as overtime vs. deadhead to or from the depots and other fixed costs of starting a route (as shown in block 201). In addition the operator also will setup other contractual or SLA related parameters.

The system is setup to work with certain dynamic features such as rush hour time, traffic conditions, or weather related conditions. Some of these parameters will be setup by users initially to account for different local traffic conditions. For example, the rush hour slowdown in Los Angles may impact the service differently than rush hour will impact service in smaller towns. Weather related parameters are either entered by the user as they see weather forecasts or may be obtained by the system from weather channels on the Internet automatically for the area of service. Traffic related issues may be directly accessed from traffic channels on the Internet. Traffic information 203 may change the trip assignments dynamically as the routes are progressing and typically will only apply to dynamic ERSS.

The system has a database 206 of vehicles and their attributes that provide the service, such as their capabilities to provide service to wheelchair passengers and their heterogeneous passenger capacities. The vehicle capacity is provided in a heterogeneous mode as a combination of wheelchair and ambulatory capacity. This disclosure covers a particular and dynamically changing capacity based on trips accepted. This is because in many commercial vehicles where a vehicle has both wheelchair and ambulatory capacities, the capacity may be converted form one type to another. For example, a vehicle may be designed for 7 ambulatories and 1 wheelchair passenger but the user may be able to fold ambulatory seats to increase the wheelchair capacity. On the other hand, if there is no wheelchair rider, the user may be able to add additional ambulatory seats. The ERSS has incorporated a formula that, as the trips are assigned, the capacity of the vehicle gets modified for future assignments dynamically. This formula is:

A=T−Round UP(W*F): where W<max wheelchair Capacity

In this formula
T is total capacity of the vehicle if there were no wheelchairs loaded
A is the dynamic ambulatory capacity of the vehicle determined at the time of inserting a new trip
F is a conversion factor based on the design of the vehicle, which specifies the number of ambulatory seats lost for each additional wheelchair loaded. For example, if each added wheelchair reduces the ambulatory capacity by 1.5 or by 2 then F is 1.5 or 2.

Static ERSS 204 is utilized when the trip data are all available before the system begins setting up routes for ride sharing. That is, the trips are pre-scheduled with certain attributes including SLA, vehicle type, such as wheelchair equipped, and other attributes. In dynamic ERSS, on the other hand, trip data 202 are received into the system as the services to previously provided trips are in progress. The system dynamically evaluates the future of each route, finds the best fit, and inserts the trip into a route that is in progress. The system in fact operates in a hybrid mode. This means it schedules the trips that are provided in advance, using the static mode. It accepts additional trips and dynamically assigns them to the routes as the routes are in progress.

ERSS block 208 takes all these parameters and the trip data and produces very efficient routes that first, meet the constraints provided by the setup parameters, and second, optimize for the cost functions based on provided business parameters and requirements. Real time performance monitoring data for management control is provided at block209. Completed trip data records for purposes of invoicing and post trip performance analysis is provided at block 210. The completed data records are used as a self-learning tool where applicable, including to look up previous addresses for address verification, and to determine trip time and distance for future estimates of time and distance. This data are used to determine routes more accurately based on time of day and traffic conditions.

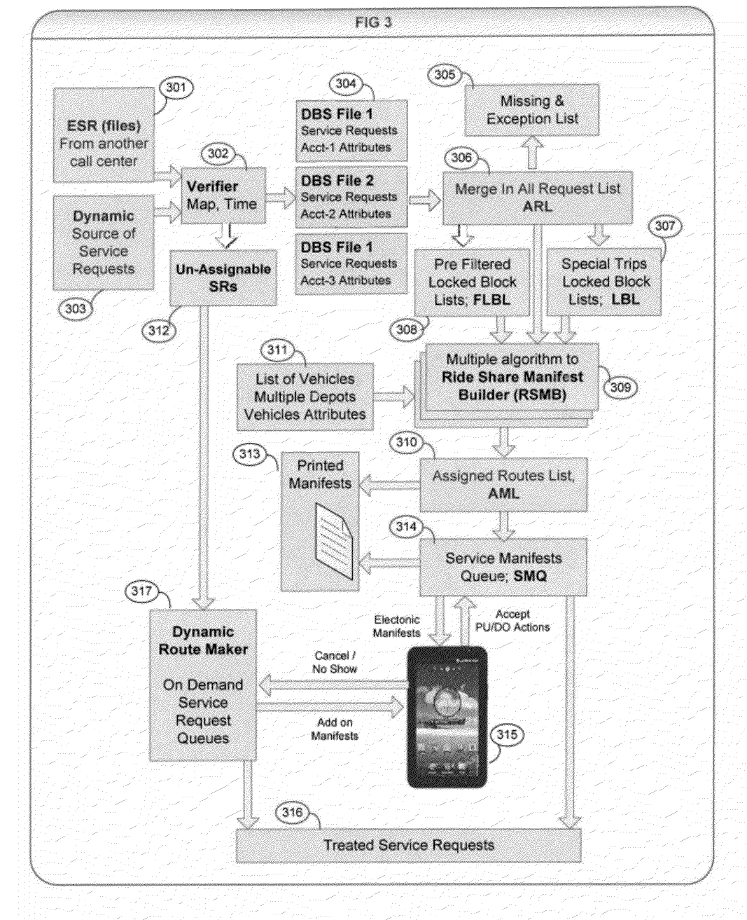

The building blocks of the ERSS are defined in a system flow diagram in FIG. 3. The ERSS starts with an address verification block 302. Every trip provided to the ERSS regardless of its method of entering needs to be verified for correct pickup and drop off addresses and a reasonable time of service. The correct address in this context is an address that can be converted to a GPS position (latitude and longitude) within a provided service area. Reasonable time of service is defined as a time that fits between the hours of operation; drop off time is always after the pickup time. This trip data may come from another center or a government institution in the form of an Electronic Service Request (ESR) 301 in batches, or it may come from a call center in a dynamic mode 303. In both cases these data will go through a verification block 302 to make sure bad data records will not create a consequential problem for the ERSS. Those trips identified as not fit for use by the ERSS will be marked as Un-Assignable to a route by the ERSS. They will be removed from the path and sent to an Un-Assignable pool 312 for management attention. Management may correct some of these records and put them back in the pool to be processed by the ERSS or they may make other special arrangements.

The ERSS can work with multiple organization files with different ESR formats and ESR content. The ERSS includes a flexible file mapping utility 304 that converts different file formats and different file content to ERSS database fields. This utility allows the ERSS to mix multiple account data sets into one batch 306 and create a common ride sharing for all these accounts. This flexibility allows ERSS to achieve higher efficiency because of the mix of multiple accounts.

Post verification and compilation of multiple account datasets, the ERSS performs a set of Trip Data Preparation. This preparation includes checking the records for certain riders that regularly use the ride sharing services on some set schedule to produce a missing trips list 305 to make sure these trips are not inadvertently omitted. The ERSS also checks the dataset to make sure there are regular trips that operators know riders will not be traveling due to various reasons, such as, for example, the regular passenger being on travel, or in the hospital. This preparation tool is used to make sure a vehicle from mobile resource pool 205 is not sent on a trip which does not require service. In a self-learning manner, the system uses certain blocks of trips as a Locked-Blocks-List (LBL) 207 which the ERSS maintains together as it makes up ride sharing routes. These LBLs are formed by the system or operator because they are very efficient and well-formed routes, or because operators want them to ride together due to rider preferences or contractual provisions. The system may form temporary blocks as well that should be kept together. These are trips that have the same start and end points or are put together for other reasons. Because these blocks are formed by a pre-filtering facility, they are named Filtered Locked Blocked List (FLBL) 308.

A list of vehicles 311 is maintained by the system that includes each vehicle desired start time and its start location or depot. The list of vehicles includes each vehicle's attributes including its capabilities, capacity and other attributes.

The list of vehicles 311 to be scheduled in ride sharing routes, LBL 207, FLBL 308, as well as all route making parameters described previously, are fed into a Rider Sharing Manifest Builder (RSMB) 309. RSMB 309 uses one of the several efficient route makers to build the ride sharing routes. The reason for using these multiplicity of route making algorithms is that different datasets may work better with different algorithms. For example, the dynamically changing dataset may work better with one algorithm, while the static dataset may require a different algorithm.

The result generated by RSMB 309 is placed in an Assigned Manifests List (AML) 310. AML 310 then goes to a Service Manifest Queue (SMQ) 314. In SMQ 314, manifests are lined up by their starting time. Each manifest may be printed and each printed manifest may be provided to a driver to perform the trips in the order of stops provided in the manifest, where a stop is referred to as a point of pick up or drop off of one passenger. Alternatively, the ERSS can automatically send each manifest to a smart device 315 of a logged in driver and request that driver to accept responsibility for performing the manifested trips. Manifests will be dispatched automatically as drivers log in to the system. If a driver who is assigned to a manifest is not logged into the system sufficiently prior to the start of a route, the system will raise an alarm to management for intervention.

The dynamic data set is handled either by the dynamic RSMB 309, which constantly rebuilds the manifest from a given time window past the current time or by the on-demand side of the system, like a taxi. The dynamic manifest builder is designed to resist exchanging trips between manifests with small gains. That means, the extra resistance creates some stability in routes, by not removing a trip from one manifest and assigning it to another, unless the gain is greater than certain weight factors or it solves a delay or performance issue. This feature is supported to avoid arbitrary reassignments of trips between routes and to avoid a potential ping-pong effect, in which the system assigns a trip to route “x” few minutes after assigning it to route “y” for a small gain and then bringing it back to route “y.” Repetitive back and forth reassignments like this creates confusion. In addition, the system allows the assignment of routes to a manifest via the on-demand side of the system and based on a bidding process by the drivers, as shown at block 317.

All processed trips with all actual performance data as well as scheduled data will be placed in a treated service request. A Treated Service Request Table (TSRT) 316 is utilized for invoicing, data mining, post processing and historical performance metrics.

### CONCLUSION

It is to be appreciated that the Detailed Description section, and not the Summary and Abstract sections, is intended to be used to interpret the claims. The Summary and Abstract sections may set forth one or more but not all exemplary embodiments as contemplated by the inventor(s), and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

What is claimed is:

1. An automated method for establishing ride-sharing routes, comprising:
receiving a plurality of requests for transportation between a plurality of start locations and a plurality of end locations;
automatically determining a route that includes the plurality of start locations and plurality of end locations as a function of at least one of the following criteria:
a service level agreement with at least one transportation requestor,
real time traffic conditions
real time weather conditions, and
distance between the first start location and the last end location;
automatically selecting a mobile resource that satisfies at least one of the criteria relied on to determine the route;
automatically transmitting the determined route information to the selected mobile resource; and
automatically receiving confirmation of the transmitted route information from the selected mobile resource.

2. The method of claim 1, further comprising:
automatically determining a sequence of pickups at the plurality of start locations and drop offs at the plurality of end locations to optimize the determined route.

3. The method of claim 2, wherein automatically selecting a mobile resource comprises:
automatically determining the total number of available mobile resources;
automatically determining the current locations of the available mobile resources at the time the route is being determined;
automatically determining which one or ones of the available mobile resources satisfy one or more of at least the following necessary criteria:
whether one or more transportation requestors is ambulatory, and
whether one or more transportation requestors is wheelchair bound; and
automatically selecting a mobile resource that satisfies the necessary criteria.

4. The method of claim 3, further comprising:
automatically transmitting route update information to the selected mobile resource as a given end location is reached.

5. The method of claim 4, further comprising:
automatically transmitting route update information to the selected mobile resource to add new start and end locations or remove start and end locations while the selected mobile resource is en route.

6. The method of claim 2, further comprising:
automatically transmitting route update information to the selected mobile resource as traffic conditions change to thereby optimize the route taken by the selected mobile resource.

7. An automated method for establishing ride-sharing routes, comprising:
receiving a plurality of requests for transportation between a plurality of start locations and a plurality of end locations;
automatically determining a plurality of routes, each of which includes one or more of the start locations and one or more of the end locations as a function of at least one of the following criteria:
a service level agreement with at least one transportation requestor,
whether one or more transportation requestors is ambulatory, and
whether one or more transportation requestors is wheelchair bound,
real time traffic conditions
real time weather conditions, and
distance between the first start location and the last end location;
automatically selecting a mobile resource for each determined route, each mobile resource satisfying at least one of the criteria relied on to determine the respective routes;
automatically transmitting respective determined route information to the respective selected mobile resource; and
automatically receiving confirmation of the transmitted route information from the selected mobile resources.

8. The method of claim 7, further comprising:
automatically determining a sequence of pickups at the plurality of start locations and drop offs at the plurality of end locations to optimize the determined route.

9. The method of claim 8, wherein automatically selecting a mobile resource comprises:
automatically determining the total number of available mobile resources;
automatically determining the current locations of the available mobile resources at the time the routes are being determined;
automatically determining which one or ones of the available mobile resources satisfy one or more of at least the following necessary criteria:
whether one or more transportation requestors is ambulatory, and
whether one or more transportation requestors is wheelchair bound; and
automatically selecting a mobile resource that satisfies the necessary criteria to be assigned to a determined route.

10. The method of claim 9, further comprising:
automatically transmitting route update information to at least one selected mobile resource as a given end location is reached.

11. The method of claim 10, further comprising:
automatically transmitting route update information to at least one selected mobile resource to add new start and end locations while that selected mobile resource is en route.

12. The method of claim 9, further comprising:
automatically transmitting route update information to at least one selected mobile resource as traffic conditions change to thereby optimize the route taken by that selected mobile resource.

13. An article of manufacture including a non-volatile computer readable medium having computer program logic stored thereon that, when executed by a computing device; cause the computing device to perform a method for automated operation of a mobile resource fleet upon receipt of a service request to dispatch a mobile resource, comprising:
receiving a plurality of requests for transportation between a plurality of start locations and a plurality of end locations;
automatically determining a route that includes the plurality of start locations and plurality of end locations as a function of at least one of the following criteria:
a service level agreement with at least one transportation requestor,
real time traffic conditions
real time weather conditions, and
distance between the first start location and the last end location;
automatically selecting a mobile resource that satisfies at least one of the criteria relied on to determine the route;
automatically transmitting the determined route information to the selected mobile resource; and
automatically receiving confirmation of the transmitted route information from the selected mobile resource.

14. The article of manufacture according to claim 13, wherein the computer program logic, when executed by the computing device, cause the computing device to perform the following additional operations, including:
automatically determining a sequence of pickups at the plurality of start locations and drop offs at the plurality of end locations to optimize the determined route.

15. The article of manufacture according to claim 14, wherein the computer program logic, when executed by the computing device, cause the computing device to perform the following additional operations, including:
automatically determining the total number of available mobile resources;
automatically determining the current locations of the available mobile resources at the time the route is being determined;
automatically determining which one or ones of the available mobile resources satisfy one or more of at least the following necessary criteria:
whether one or more transportation requestors is ambulatory, and
whether one or more transportation requestors is wheelchair bound; and
automatically selecting a mobile resource that satisfies the necessary criteria.

16. The article of manufacture according to claim 15, wherein the computer program logic, when executed by the computing device, cause the computing device to perform the following additional operations, including:
automatically transmitting route update information to the selected mobile resource as a given end location is reached.

17. The article of manufacture according to claim 16, wherein the computer program logic, when executed by the computing device, cause the computing device to perform the following additional operations, including:
automatically transmitting route update information to the selected mobile resource to add new start and end locations while the selected mobile resource is en route.

18. The article of manufacture according to claim 14, wherein the computer program logic, when executed by the computing device, cause the computing device to perform the following additional operations, including:
automatically transmitting route update information to the selected mobile resource as traffic conditions change to thereby optimize the route taken by the selected mobile resource.

19. An article of manufacture including a non-volatile computer readable medium having computer program logic stored thereon that, when executed by a computing device, cause the computing device to perform a method for automated operation of a mobile resource fleet upon receipt of a service request to dispatch a mobile resource, comprising:
receiving a plurality of requests for transportation between a plurality of start locations and a plurality of end locations;
automatically determining a plurality of routes, each of which includes one or more of the start locations and one or more of the end locations as a function of at least one of the following criteria:
a service level agreement with at least one transportation requestor,
whether one or more transportation requestors is ambulatory, and
whether one or more transportation requestors is wheelchair bound,
real time traffic conditions
real time weather conditions, and
distance between the first start location and the last end location;
automatically selecting a mobile resource for each determined route, each mobile resource satisfying at least one of the criteria relied on to determine the respective routes;
automatically transmitting respective determined route information to the respective selected mobile resource; and
automatically receiving confirmation of the transmitted route information from the selected mobile resources.

20. The article of manufacture according to claim 19, wherein the computer program logic, when executed by the computing device, cause the computing device to perform the following additional operations, including:
automatically determining the total number of available mobile resources;
automatically determining the current locations of the available mobile resources at the time the routes are being determined;
automatically determining which one or ones of the available mobile resources satisfy one or more of at least the following necessary criteria:
whether one or more transportation requestors is ambulatory, and
whether one or more transportation requestors is wheelchair bound; and
automatically selecting a mobile resource that satisfies the necessary criteria to be assigned to a determined route.
